(19) United States
(12) Patent Application Publication
(10) Pub. No.: US 2023/0344069 A1
(43) Pub. Date: Oct. 26, 2023

(54) MITIGATING THERMAL RUNAWAY PROPAGATION IN LITHIUM-ION BATTERY PACKS

(71) Applicant: BAE Systems Controls Inc., Endicott, NY (US)

(72) Inventors: William J. Doak, Apalachin, NY (US); Christopher P. Akulis, Binghamton, NY (US); Peter J. Arnold, Endicott, NY (US); Matthew S. Boecke, Endicott, NY (US); Dan A. Snavely, Binghamton, NY (US); Joshua P. Stewart, Vestal, NY (US)

(73) Assignee: BAE Systems Controls Inc., Endicott, NY (US)

(21) Appl. No.: 18/028,906

(22) PCT Filed: Sep. 30, 2021
(86) PCT No.: PCT/US21/52890

§ 371 Date: Mar. 28, 2023

Related U.S. Application Data
(60) Provisional application No. 63/086,382, filed on Oct. 1, 2020.

(51) Int. Cl. H01M 50/342; H01M 10/658; H01M 10/0525; H01M 50/213

(52) U.S. Cl. CPC H01M 50/3425; H01M 10/658; H01M 10/0525; H01M 50/213; H01M 2200/20

(57) ABSTRACT

A lithium-ion battery assembly includes a plurality of battery cells in a spaced-apart and generally parallel arrangement, each cell of the battery cells extending along a central axis and having a first end portion with a negative terminal and a second end portion with a positive terminal. The assembly includes a first capture plate and a second capture plate, where at least the first capture plate defines capture plate openings corresponding to the plurality of battery cells, the first capture plate spaced from and oriented generally parallel to the second capture plate. Each of the plurality of battery cells extends between the first and second capture plates and is coaxially arranged with one of the capture plate openings in the first capture plate. The assembly optionally includes a body between the capture plates, the body defining a void for each battery cell.

### TECHNICAL FIELD

The present disclosure relates generally to battery technology, and more specifically to mitigation of thermal runaway propagation in battery packs.

### BACKGROUND

A lithium-ion battery or Li-ion battery is a type of rechargeable battery with a high energy density and generally no memory effect. The batteries can be used individually, or together in groups that are packaged in a battery pack. Li-ion batteries and battery packs are commonly used in portable electronic devices (e.g., cell phones), electric vehicles, and cordless power tools for consumers, for example. The Li-ion battery is also used in military and aerospace applications.

The Li-ion cell provides electric current when lithium ions move through an electrolyte from a negative electrode to a positive electrode. Lithium ions move in the reverse direction when charging the cell. In some examples, the positive electrode includes lithium cobalt oxide (LiCoO₂), lithium iron phosphate (LiFePO₄), or lithium manganese oxide (LiMn₂O₄ or Li₂MnO₃). The negative electrode commonly includes graphite. The electrolyte can be a mixture of organic carbonates and lithium ion complexes. For example, the electrolyte can include ethylene carbonate or diethyl carbonate.

Lithium ion cells can have a variety of form factors, including a cylinder, a flat, a pouch, and a rigid plastic case with threaded terminals. In one example, a cylindrical lithium-ion cell typically includes a metal container that provides the primary structure to the cell and serves as the negative electrode. The container can be made of aluminum or steel. An electrode assembly or “jelly-roll” includes current collector sheets separated by porous membranes rolled into a cylindrical shape. The electrode assembly is placed in the container and functions as the electrical energy storage component. The current collectors may include copper or aluminum foil coated with an active material, and the porous membranes can be a polymer or ceramic. An electrolyte fills the remaining volume of the container and permeates the active material on the current collectors and separators. A cap, which serves as the positive electrode, is crimped in place on the top of the can to complete the cell and enclose the electrode assembly within the container.

Lithium-ion battery cells may also include a positive temperature coefficient disk (“PTC disk”) and/or a current interrupt device (“CID”) between the electrode assembly and the cap as protective devices. For example, the PTC disk is made of a material that exhibits increased electrical resistance at elevated temperatures, thereby reducing current flow at higher temperatures. When pressures inside the cell exceed a threshold value the CID device, such as a pressure plate, may rupture to break the electrical connection and vent gases from the cell.

### SUMMARY

The present disclosure is directed methodologies and battery assemblies configured to mitigate or inhibit propagation of thermal runaway. In one example, the battery assembly is a cell module or a battery pack, such as a lithium-ion battery pack. Numerous embodiments will be appreciated in light of this disclosure.

### BRIEF DESCRIPTION OF THE DRAWINGS

FIG. 1 is a cross-sectional view of a lithium-ion battery cell, in accordance with an embodiment of the present disclosure.

FIG. 2A is a top view of a battery pack or cell module with battery cells arranged in a rectangular grid, in accordance with an embodiment of the present disclosure.

FIG. 2B is a top view of a battery pack or cell module with battery cells arranged in a triangular grid, in accordance with an embodiment of the present disclosure.

FIG. 3 is a cross-sectional view of part of a battery pack and shows a single battery cell, in accordance with an embodiment of the present disclosure.

FIG. 4A is a perspective view of a battery cell with a layer of fire-resistant material around the container sidewall, in accordance with an embodiment of the present disclosure.

FIG. 4B is a perspective view of a battery cell with fire-resistant material around end portions of a battery cell, in accordance with an embodiment of the present disclosure.

FIG. 4C is a perspective view of a battery cell with fire-resistant material and a sleeve around the container, in accordance with an embodiment of the present disclosure.

FIG. 5 is a cross-sectional view of a battery cell of a battery pack showing ejecta from the positive terminal during a thermal runaway event, in accordance with an embodiment of the present disclosure.

FIG. 6 is a perspective, partially exploded view of a cell module that includes battery cells each having end portions wrapped in a fire-resistant material and a layer of fire-resistant material around the assembly of battery cells, in accordance with an embodiment of the present disclosure.

FIG. 7 is a perspective, partially exploded view of a battery pack assembly, in accordance with an embodiment of the present disclosure.

FIG. 8 is a cross-sectional view of a battery pack that includes cell modules spaced and physically separated from each other within a housing, in accordance with an embodiment of the present disclosure.

The figures depict various embodiments of the present disclosure for purposes of illustration only and are not necessarily drawn to scale. Numerous variations, configurations, and other embodiments will be apparent from the following detailed discussion.

### DETAILED DESCRIPTION

Disclosed are methodologies and structures for mitigating propagation of thermal runaway in a battery pack, such as lithium-ion battery packs. In accordance with some example embodiments, a battery assembly is a cell module or battery pack that includes a plurality of battery cells in a spaced-apart and generally parallel arrangement. As part of a thermal management strategy, the battery cells are arranged to prevent direct contact between battery cells and to avoid a line-of-sight from one battery cell to another.

In one example, each battery cell extends along a central axis and has a first end portion with a negative terminal and a second end portion with a positive terminal. Each battery cell is received in a void defined in a body, sometimes referred to as a honeycomb. A first capture plate is on one side of the body and a second capture plate is on the opposite side of the body. At least the first capture plate defines capture plate openings corresponding to the battery cells such that each of the plurality of battery cells extends between the first and second capture plates and is coaxially arranged with one of the capture plate openings. For example, the body extends the entire axial length of the battery cells so that any ejecta from a battery cell is directed axially away from the cell through the capture plate opening.

In some embodiments of the present disclosure, the body can be made of a thermally conductive material, such as aluminum, where the body functions as a heat sink and draw away heat from a battery cell undergoing thermal runaway, for example. In other embodiments of the present disclosure, the body can be made of a thermally insulating material and functions to inhibit the spread of heat to adjacent battery cells during a thermal runaway event. Optionally, a fire-resistant material, or potting material, can be placed in the capture plate openings to shield the end of the battery cell from ejecta emitted from a nearby battery cell.

A plurality of cell modules each having a plurality of battery cells, such as described above, can be assembled together within a battery pack housing. The battery cells are arranged, and the cell modules are constructed, to eliminate a direct line of sight with another battery cell in the battery pack. In some embodiments of the present disclosure, each cell module is configured so that the positive terminals of the battery cells are directed outward toward the housing. The battery pack can optionally include one or more partitions of fire-resistant material that physically separate adjacent cell modules. Optionally, each cell module can be wrapped with a fire-resistant material.

The present disclosure is described with reference to lithium-ion battery cells and battery assemblies. However, the principles and structures disclosed herein can be applied to battery assemblies utilizing other chemistries, as will be appreciated. Numerous variations and embodiments will be apparent in light of the present disclosure.

General Overview

There remain some non-trivial issues with respect to lithium-ion battery packs. One challenge of lithium-ion battery technology is thermal management. An ongoing concern is the possibility of thermal runaway during use, handling, or transportation of lithium-ion batteries. Thermal runaway occurs when a series of self-sustaining exothermic side-reactions lead to total failure of the cell and, in some cases, fire and/or explosion. A battery cell undergoing a thermal runaway may emit hot gases, flames, and high-velocity jets of molten particulate matter, referred to as ejecta. Most lithium-ion batteries have the potential to experience thermal runaway due to the chemical nature of the lithium-ion technology. Although significant progress has been made over time to improve cell performance (e.g., reducing capacity fade, increasing available power, etc.), challenges of thermal runaway and its propagation persist. For example, the materials and construction of individual battery cells or of the battery pack can result in a localized hot spot or heating that results in cell failure. Also, over-constraining a battery cell can result in large pressure gradients that lead to failure of mechanical components, such as plates and fasteners around a battery cell. Similarly, not letting the ejecta escape can lead to instantaneous formation of local hot spots that can trigger thermal runaway in nearby battery cells. Therefore, a need exists for structures and methodologies for mitigating the propagation of thermal runaway in lithium-ion battery packs.

The present disclosure addresses this need and others. In accordance with some embodiments of the present disclosure, thermal runaway propagation can be mitigated or halted altogether using an approach that considers multiple design factors, including (i) an individual battery cell undergoing thermal runaway, (ii) cells neighboring a cell or cell module undergoing thermal runaway, (iii) battery cell packaging materials, and (iv) the spatial and structural relationship of a battery cell or cell module to an adjacent battery cell or cell module undergoing a thermal runaway event.

In more detail, and as will be appreciated in light of this disclosure, mitigating or halting propagation of thermal runaway involves controlling various aspects of ejecta, including controlling how ejecta exits the battery cell, controlling the path of ejecta and other objects directly in that path, and controlling the landing point of ejecta particulates. For example, providing sufficient structure around a battery cell can be used to direct ejecta axially away from a cell module and from adjacent battery cells.

When thermal runaway does occur, propagation of thermal runaway can be mitigated or halted by considering the relationship of adjacent battery cells or cell modules. For example, battery cells adjacent a thermal runaway event can go into thermal runaway if the bulk temperature of the battery cells exceeds the melting point (or threshold temperature) of the separator material between the anode and cathode. Such condition can be referred to as bulk heating failure. In one example, bulk heating failure can occur when the temperature of packaging material exceeds the threshold temperature of the cells for a time sufficient to allow one or more battery cells to reach or exceed the threshold temperature.

Bulk heating failure can be mitigated by careful selection of the packaging materials of battery cells, such as the material of the body (or “honeycomb”) containing the battery cells. In one example embodiment of the present disclosure, the body can be made of a thermally conductive material, such as aluminum or copper. The body can be configured to have sufficient thermal mass and thermal conductivity to conduct heat away from a thermal runaway event such that the bulk temperature does not exceed the threshold temperature. Alternately, the body can be made of a thermally insulating material. In such an embodiment, the body material insulates battery cells such that none of the battery cells adjacent a thermal runaway event exceeds the threshold temperature. When a thermally insulating material is used, the insulating material should be able to maintain its integrity (i.e., not melt) throughout the duration of a thermal runaway event.

Battery cells adjacent a thermal runaway event can also go into thermal runaway if a heat source increases the temperature of a portion of the battery cell above the melting point (or threshold temperature) of the separator material between the anode and the cathode. This condition can be referred to as local heating failure. Local heating failure can occur, for example, when a battery cell is exposed to direct contact with flames or ejecta from a cell in thermal runaway. In one embodiment of the present disclosure, local heating failure and bulk heating failure can be mitigated or halted by wrapping the battery cell in a flame-resistant or fire-resistant material capable of withstanding flames and ejecta, and/or by encapsulating or covering exposed battery cell ends with a high-temperature and flame-resistant material (or “potting material”).

The relationship of adjacent cell modules or adjacent battery cells can also be configured to mitigate or halt propagation of thermal runaway. In some battery packs, individual lithium-ion battery cells are combined by a set of series and parallel connections. It some such embodiments, it may be impractical to connect all of the battery cells together in a single one-layer slab. Accordingly, the battery pack may be divided into subsections, or cell modules, each having some arrangement of series and parallel connections. The cell modules can be assembled into a battery pack. If a battery cell in any of the modules goes into thermal runaway, it can pose an imminent threat to an adjacent cell module. To mitigate this propagation, a battery pack can be assembled to include one or more layers of flame-resistant or fire-resistant material, such as glass pack, fiberglass, metal mesh, an alkaline earth silicate wool, or an intumescent tape. One such product is sold as FyreWrap® by Unifrax. In some such embodiments, adjacent cell modules wrapped in fire-resistant materials can be separated by air gaps. In another example embodiment, the fire-resistant material can be formed into baffles that prevent line-of-sight between adjacent cell modules.

In accordance with some embodiments of the present disclosure, these various approaches can be used individually or together to mitigate or eliminate thermal runaway propagation in a battery pack assembly. Numerous variations and embodiments will be apparent in light of the present disclosure.

As used in the discussion and claims herein, the term “about” indicates that the value listed may be somewhat altered, as long as the alteration does not result in nonconformance of the process or device. For example, for some elements the term “about” can refer to a variation of ±0.1%, for other elements, the term “about” can refer to a variation of ±1% or ±10%, or any point therein. As also used herein, terms defined in the singular are intended to include those terms defined in the plural and vice versa.

Reference herein to any numerical range expressly includes each numerical value (including fractional numbers and whole numbers) encompassed by that range. To illustrate, reference herein to a range of “at least 50” or “at least about 50” includes whole numbers of 50, 51, 52, 53, 54, 55, 56, 57, 58, 59, 60, etc., and fractional numbers 50.1, 50.2 50.3, 50.4, 50.5, 50.6, 50.7, 50.8, 50.9, etc. In a further illustration, reference herein to a range of “less than 50” or “less than about 50” includes whole numbers 49, 48, 47, 46, 45, 44, 43, 42, 41, 40, etc., and fractional numbers 49.9, 49.8, 49.7, 49.6, 49.5, 49.4, 49.3, 49.2, 49.1, 49.0, etc.

As used herein, the term “substantially”, or “substantial”, is equally applicable when used in a negative connotation to refer to the complete or near complete lack of an action, characteristic, property, state, structure, item, or result. For example, a surface that is “substantially” flat would either completely flat, or so nearly flat that the effect would be the same as if it were completely flat.

Architecture

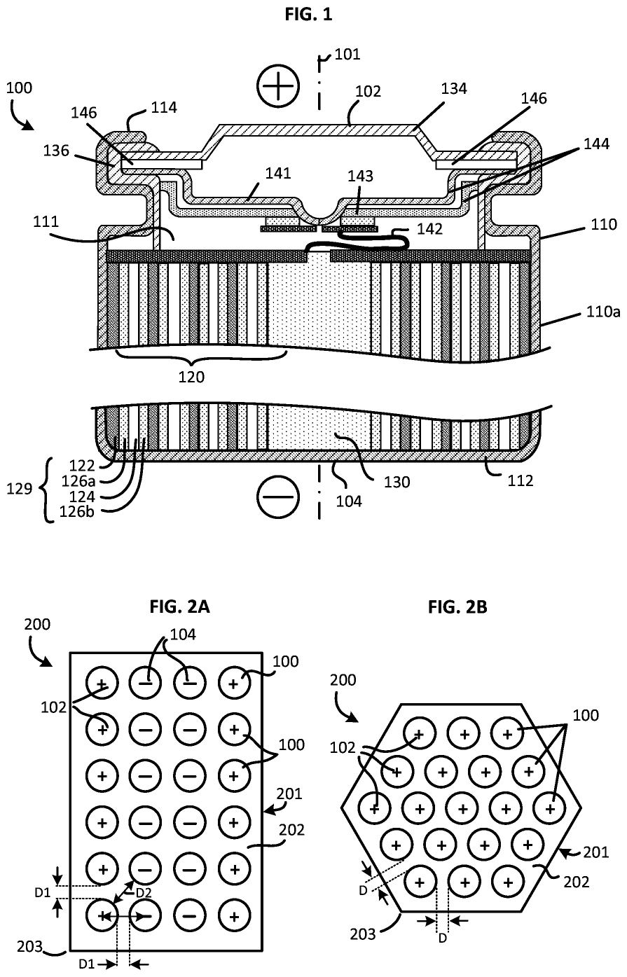

Referring to FIG. 1, a cross-sectional view illustrates part of a battery cell 100 having a cylindrical shape oriented along a central axis 101, in accordance with an embodiment of the present disclosure. In this example, the battery cell 100 includes a container 110 that encloses a volume 111 sized to contain an electrode assembly 120 and an electrolyte 130. The electrode assembly 120 (also referred to as a “jelly roll”) includes a first current collector 122, a second current collector 124, a first separator 126a, and a second separator 126b arranged in a layered stack 129 where the current collectors 122, 124 are interleaved with the separators 126. The stack 129 is then rolled into a cylindrical shape to form the spiral-wound electrode assembly 120 as illustrated in FIG. 1, for example. The battery cell 100 can have any standard or non-standard dimensions, including diameter and length of 18 mm×65 mm, 21 mm×70 mm, and 26 mm×65 mm, to name a few examples.

In one example, the container 110 is made of metal or other electrically conductive material and has a container sidewall 110a extending axially between a closed first end 112 (e.g., bottom end) and an open second end 114 (e.g., top end). In some embodiments, the container 110 functions as the negative terminal 104 of the battery cell 100. Suitable materials for the container 110 include aluminum, aluminum alloys, and steel, among other electrically conductive materials.

In one example, the first current collector 122 comprises a first electrode material and the second current collector 124 comprises a second electrode material. In accordance with some embodiments, the first electrode material may be selected as an anode material and the second electrode material may be selected as a cathode material, or vice versa.

Examples of the first electrode material include aluminum (Al), lithium (Li), sodium (Na), potassium (K), calcium (Ca), magnesium (Mg), alloys for these elements, carbon or graphite material capable of intercalation (such as lithiated carbon, Li_{X}Ti₅O₁₂), silicon (Si), tin (Sn), and combinations thereof of any of these materials.

In one embodiment, the second electrode material comprises a fluorinated carbon represented by the formula (CFₓ)ₙ or (C₂F)ₙ, where x is from about 0.5 to about 1.2 (also referred to as graphite fluoride, carbon monofluoride, and other terms). Other suitable materials for the second electrode material include copper sulfide (CuS), copper oxide (CuO), lead dioxide (PbO₂), iron sulfide (FeS), iron disulfide (FeS₂), pyrite, copper chloride (CuCl₂), silver chloride (AgCl), silver oxide (AgO, Ag₂O), sulfur (S), bismuth oxide (Bi₂O₃), copper bismuth oxide (CuBi₂O₄), cobalt oxides, vanadium oxide (V₂O₅), tungsten trioxide (WO₃), molybdenum trioxide (MoO₃), molybdenum disulfide (MoS₂), titanium disulfide (TiS₂), transition metal polysulfides, lithiated metal oxides and sulfides (e.g., lithiated cobalt and/or nickel oxides), lithiated manganese oxides, lithium titanium sulfide (LiₓTiS₂), lithium iron sulfide (LiₓFeS₂), lithium iron phosphate (LiFePO₄), lithium iron niobium phosphate (LiFeNbPO₄), and mixtures of any of the foregoing materials.

Each separator 126 can comprise one or more materials, such as an insulating material, an impermeable material, a substantially impermeable material or a microporous material, the material selected from one or more of polypropylene, polyethylene, and combinations thereof. The material of each separator 126 can include a filler, such as oxides of aluminum, silicon, titanium, and combinations thereof. Each separator 126 can also be produced from microfibers, such as by melt blown nonwoven film technology. Each separator 126 can have a thickness from about 8 to about 30 microns, or thicker. Each separator 126 may also have few or no pores. In one example, one or both separators 126 includes pores having a pore size in a pore size range from about 0.005 to about 5 microns, or a pore size range from about 0.005 to about 0.3 microns. Each separator 126 can have little or no porosity or can have a porosity range from about 30 to about 70 percent, preferably from about 35 to about 65 percent in some embodiments.

The volume 111 within the container 110 that is not filled by the electrode assembly 120 (and any other components inside the container 110) is occupied by a liquid electrolyte 130. The electrolyte 130 contacts surfaces of the first current collector 122, the second current collector 124, and the separators 126. In some embodiments, the electrolyte 130 permeates separators 126 and/or active materials on the first current collector 122 and second current collector 124. The electrolyte 130 can be any suitable electrolyte, typically in liquid form, such as a solution of lithium hexafluorophosphate (LiPF₆).

The battery cell includes a cap 134 attached to the container 110 in any suitable way, thus closing the second end 114 of the container 110 and forming a liquid-tight volume 111 within the container 110. The cap 134 is electrically isolated from the container 110 by a gasket 136. The cap 134 can be configured as a terminal (e.g., the positive terminal) of the battery cell 100. In one example, the first current collector 122 is electrically connected to the container 110 and the second current collector 124 is electrically connected to the cap 134, or vice versa, such as by a tab, wire, physical contact, or other suitable electrical connector.

The battery cell 100 optionally includes a suitable current interrupter device (CID) 140 between the cap 134 and the electrode assembly 120. In this example the CID 140 includes a pressure disk 141 that is designed to rupture with excessive pressure within the battery cell 100, thereby disconnecting current flow and venting gases through the second end 114 of the container 110. The CID 144 includes an electrical connector 143 (e.g., a plate or disk) and any additional electrical connector 142 (e.g., wire or tab) in electrical contact with the first current collector 122 or second current collector 124. During operation, electrons flow from one current collector to the other (e.g., from the first current collector 122 to the second current collector 124) to generate a current when the battery cell 100 is connected at the container 110 and cap 134.

The battery cell 100 optionally includes a positive temperature coefficient disk (PTC disk) 146 in the current path to the cap 134. For example, the PTC disk 146 is between the CID and the cap 134. The PTC disk 146 can be a ceramic or other suitable material or combination of materials having increasing resistance with increasing temperature, as will be appreciated. The PTC disk 146 functions to reduce current flow of the battery cell 100 during elevated temperatures. In some embodiments, the PTC disk 146 has a circular shape; in other embodiments, the PTC disk 146 has an annular shape. Numerous variations and embodiments will be apparent in light of the present disclosure.

Referring now to FIGS. 2A and 2B, a plurality of battery cells 100 can be assembled into a battery pack 200, such as shown here looking at ends or terminals of battery cells 100. Similarly, battery cells 100 can be assembled into a cell module 150, a plurality of which are assembled to make the battery pack 200. The properties of the battery pack 200 discussed in these examples can equally apply to a cell module 150 in accordance with some embodiments. Details of a battery pack 200 are discussed in more detail below.

In these examples of FIGS. 2A-2B, the battery cells 100 each have a cylindrical shape and adjacent battery cells 100 are oriented with central axes 101 (shown in FIG. 1) generally parallel to one another and generally parallel to a sidewall 201 of the body 202. Ends or terminals of the battery cells 100 are arranged in a rectangular or triangular lattice or grid. In some embodiments, all positive terminals 102 face the same direction, such as in FIG. 2B; in other embodiments, some positive terminals 102 face in an opposite direction from other positive terminals 102, such as in FIG. 2A. The battery pack 200 (or cell module 150) can contain any number of battery cells 100, including 2, 3, 4, 8, 10, 20, 30, 50, 100 or other number as needed for a particular voltage or application. Also, the overall shape of the battery pack 200, cell module 150, or other subset of a battery pack 200, can have any one of a variety of geometries, including rectangular, hexagonal, triangular, irregular, or combination of such shapes, as will be appreciated. Battery cells 100 can be arranged in a uniform or non-uniform rectangular lattice (e.g., a square lattice), a uniform or non-uniform hexagonal lattice, a uniform or non-uniform triangular lattice, to name a few example.

As shown in FIG. 2B, for example, each battery cell 100 has at least three adjacent battery cells 100 where each adjacent battery cell 100 is positioned the same or substantially the same distance D away. For example, battery cells 100 located at vertices of the hexagonal shape have three adjacent battery cells 100, all of which are spaced the same distance D from the battery cell 100 at the vertex. In contrast, each battery cell 100 at the corner vertex 203 shown in FIG. 2A has two adjacent battery cells 100 spaced distance D1 and one more battery cell 100 positioned on the diagonal with distance D2 that is greater than D1, as will be appreciated. Regardless of the arrangement, the distance D between the outside surface (e.g., container sidewall 110a) of adjacent battery cells 100 or outside surface of fire-resistant material 210 around container 110 can be equal to or substantially equal to the thickness of the body 202 between adjacent voids 204. This distance D can be at least 1 mm, at least 1.5 mm, at least 2 mm, at least 3 mm, at least 5 mm, at least 7 mm, at least 10 mm, not greater than 10 mm, not greater than 7 mm, not greater than 5 mm, not greater than 3 mm, not greater than 2 mm, not greater than 1.5 mm, not greater than 1 mm, or inclusive ranges between any of these values.

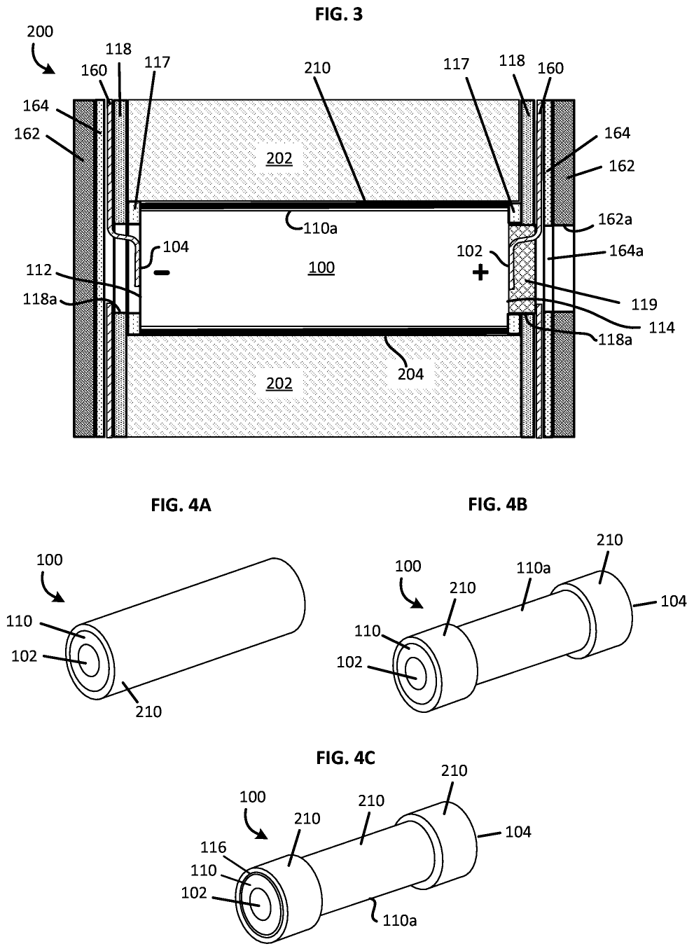

Referring now to FIG. 3 a cross-sectional view shows a battery cell 100 as part of a battery back 200, in accordance with an embodiment of the present disclosure. The battery cell 100 is retained in a void 204 defined in a block or body 202. In some embodiments, the body 202 is referred to as a honeycomb due to structure of the interstitial material between adjacent voids 204.

In some embodiments, the body 202 is made of a thermally conductive material, such as aluminum. In such an approach, the body 202 has sufficient thermal mass to conduct heat away from a battery cell 100 undergoing thermal runaway so that the temperature of adjacent battery cells 100 does not exceed the cell threshold temperature. The appropriate material may depend on the size and configuration of each battery cell 100 and the distance between battery cells 100 in a battery pack 200 or cell module 150, as will be appreciated. Conversely, the material of the body 202 and/or parameters of the battery cells 100 in the battery pack 200 may dictate the minimum cell spacing, such as operating temperature, physical dimensions, current capacity, materials, etc.

In other embodiments, the body 202 is made of a thermally insulating material such that neighboring battery cells 100 are sufficiently insulated from the heat of a battery cell 100 undergoing a thermal runaway event so as to avoid inducing thermal runaway in the neighboring battery cell(s) 100. Examples of some suitable materials include high-temperature plastics, such as a 30% glass-reinforced polyetherimide sold as Ultem™ 2300, a polyetheretherketone (PEEK) material sold by Ensinger as Tecapeek®, and polyamide-imide sold by Solvay as Torlon®.

In some embodiments, each void 204 in the body 202 has a geometry consistent with that of the battery cell 100, including any fire-resistant material 210 and/or sleeve 116 that may be around the battery cell 100. In this example, the void 204 is cylindrical to receive the cylindrical shape of the battery cell 100 together with one or more layers of fire-resistant material 210 wrapped around the battery cell 100. The void 204 can be sized to provide a snug fit to the battery cell 100. A snug fit can enhance heat transfer between the battery cell 100 and the body 202 and also provide structural support to the container 110 (shown in FIG. 1). In some embodiments, the body 202 extends at least the axial length of the battery cell 100. In this example, the body 202 extends axially beyond the positive terminal 102 and beyond the negative terminal 104. An annular gasket 117 in the void 204 adjacent the battery cell 100 makes up the axial length difference at each terminal 102, 104 between the battery cell 100 and the face of the body 202. The gasket 117 can be made of foam, plastic, rubber, metal, or other suitable material.

In other embodiments, the void 204 can have a different cross-sectional geometry compared to that of the battery cell 100. For example, the void 204 can have a hexagonal cross-sectional shape sized to snugly receive a cylindrical battery cell 100. Such an embodiment can direct ejecta 300 axially away from the battery cell 100 via spaces between the body 202 and the battery cell 100 along vertices of the hexagonal shape. In the event of a breach of the container 110 along the container sidewall 110a or first end 112, gases can escape along pathways between the body 202 and the container sidewall 110a to reduce pressure within the battery cell 100. In doing so, escaping gases are directed axially away from the positive terminal 102, which may also vent at the same time.

A capture plate 118 is against each face of the body 202 and defines a capture plate opening 118a for each terminal 102, 104 of the battery cell 100. In general, the size of each capture plate opening 118a is smaller than the diameter of the battery cell 100 so as to prevent escape of the battery cell 100 from the body 202. In some embodiments, the capture plate opening 118a is about 80-90%, or about 85% of the diameter of the battery cell 100. This size of the capture plate opening 118a is large enough to allow the battery cell 100 to vent from the positive terminal 102 during a thermal runaway event without being overly constrained, yet is small enough to effectively retain the battery cell 100 in the body 202.

In some embodiments, one or both capture plates 118 are made of a thermally conductive material such as aluminum, copper, steel, alloys of these materials, or other metal. As such, the capture plate 118 can function as a heat sink to draw away heat from one or both ends (e.g., terminals 102 or 104) of the battery cell 100. In one example, the gasket 117 is omitted at the negative terminal 104 so that the first end 112 (e.g., bottom end) directly contacts the capture plate 118. In some such embodiments, the capture plate 118 directly contacts the negative terminal 104 and functions as a heat sink to draw heat away from the end of the battery cell 100.

At the positive terminal 102, a fire-resistant material or potting material 119 can be used to fill the space left open by the annular gasket 117 and the capture plate opening 118a. As shown in this example, the outside surface of the potting material 119 is substantially flush with the outermost surface of the capture plate 118. In other embodiments, the potting material 119 may be flush with the bus bar 160, or even with a location between the capture plate 118 and bus bar 160. The potting material can be a high-temperature foam, a polymer, a flame-resistant material, or other suitable material that protects the exposed end of a battery cell 100 from ejecta emitted from another cell during a thermal runaway event, while also not inhibiting the vent or ejection function of the battery cell 100 during a thermal runaway event.

Optionally, potting material 119 can be placed between the first end 112 (e.g., negative terminal 104) of the battery cell 100 and spacer 164 or cold plate 162. For example, neither the cold plate 162 nor spacer 164 adjacent the first end 112 defines an opening; thus, potting material 119 optionally can be used to fill any open space between the first end 112 of the battery cell 100 and the spacer 164. In other embodiments, this open space remains unfilled so that the first end 112 of the battery cell 100 can vent to reduce pressure within the battery cell 100.

In some embodiments, a spacer 164 abuts the outside face of the bus bar 160 and a cold plate 162 abuts the outside face of the spacer 164 at each of the first end 112 and second end 114 of the battery cell 100. At the second end 114, the spacer 164 defines a spacer opening 164a and the cold plate 162 defines a cold plate opening 162a, each of which is generally concentric with and positioned over the second end 114 of the battery cell 100 to permit ejecta to escape in the event of a thermal runaway event, for example. In contrast, the spacer 164 and cold plate 162 adjacent the first end 112 are continuous and do not define opening, in accordance with some embodiments. The spacer 164 can be of a thermally and electrically insulating material, such as a plastic. In such embodiments, the spacer 164 electrically isolates the cold plate 162 from the bus bar 160. The cold plate can be of a metal, composite, or other structurally rigid material.

All or part of the outside of the battery cell 100 can be wrapped in a fire-resistant material 210, except to permit electrical connections with the positive terminal 102 and negative terminal 104, in accordance with some embodiments. The fire-resistant material 210 can provide thermal and/or electrical isolation of the battery cell 100. Examples of fire-resistant material 210 include mica tape and a meta-aramid material (a.k.a. polycarbonamide) made by Dow Chemical and sold as Nomex® tape. In most cases, one or more layers of the fire-resistant material 210 are tightly wrapped around the container sidewall 110a and the wrapped battery cell 100 is placed in the body 202 with the fire-resistant material 210 in contact with the body 202.

In one example as shown in FIG. 4A, the fire-resistant material 210 is around the cylindrical container sidewall 110a, but does not cover the positive terminal 102 or negative terminal 104. In another example such as shown in FIG. 4B, the fire-resistant material 210 is around only end portions of the container sidewall 110a adjacent the positive terminal 102 and adjacent the negative terminal 104, but does not cover the terminals 102, 104. In one such embodiment, a middle portion of the container 110 is devoid of fire-resistant material 210. In yet another example as shown in FIG. 4C, fire-resistant material 210 can be wrapped around end portions of the container 110, and a middle portion of the container sidewall 110a has a reduced thickness of fire-resistant material 210 or is devoid of fire-resistant material 210. In some such embodiments, the fire-resistant material 210 is only around the end portions of the battery cell 100. Optionally, a sleeve 116 is around the container sidewall 110a between the fire-resistant material 210 and container 110 to provide structural support to the container 110 and to prevent a sidewall breach during a thermal runaway event, for example. In one embodiment, the sleeve 116 is made of stainless steel or similar material that provides structural support to the container 110. The sleeve 116 can be used when the container 110 does not contact or otherwise receive structural support from the body 202, for example.

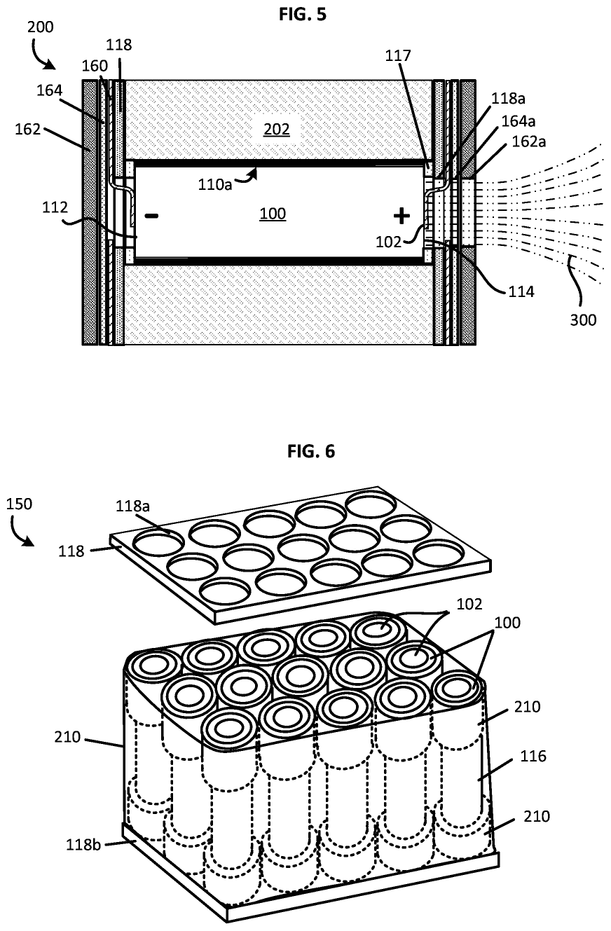

FIG. 5 illustrates the cross-sectional view of part of the battery pack 200 of FIG. 4 in an example of a thermal runaway event of the battery cell 100, in accordance with one embodiment. Here, the temperature of the battery cell 100 has exceeded the threshold temperature, resulting in failure of the current interrupter device 144 (shown in FIG. 1) and ejecta 300 is emitted from the positive terminal 102 at the second end 114. In some embodiments, ejecta 300 may pass through the potting material 119 such that the potting material 119 (shown in FIG. 4) remains partially intact adjacent the second end 114. In other embodiments, the ejecta 300 may dislodge or destroy all or part of the potting material 119.

A passageway is defined from the second end 114 to the ambient via the opening in the annular gasket 117, capture plate opening 118a, cold plate opening 162a, and spacer opening 164a, where the passageway directs ejecta 300 axially away from the second end 114. The container sidewall 110a is structurally supported by the body 202, which closely abuts or contacts the battery cell 100 or fire-resistant material 210 around the battery cell 100. The first end 112 can vent to a limited extent towards the spacer 164 and cold plate 162 adjacent the first end 112, although any such venting is obstructed by the spacer 164 and cold plate 162, thereby protecting adjacent battery cells 100 from ejecta 300. Due to pressure-relief features of the current interrupter device 140 and pressure disk 141, ejecta 300 is expected to exit primarily or exclusively through the positive terminal 102 at the second end 114.

FIG. 6 illustrates a perspective view of a plurality of battery cells 100 packaged together in a cell module 150, in accordance with an embodiment of the present disclosure. A top capture plate 118 is shown separated from the assembly in this example for clarity of illustration. The top capture plate 118 defines capture plate openings 118a that are positioned over the positive terminals 102 when the top capture plate 118 is assembled with the cell module 150. In this example, the bottom capture plate 118b is solid or continuous (i.e., no capture plate openings 118a) to shield the negative terminals 104 (not visible). In this embodiment, each battery cell 100 includes a sleeve 116 around the container 110 to reinforce the container 110 and reduce the likelihood of a breach in the container sidewall 110a. For example, the sleeve 116 is made of steel and extends the entire axial length of each battery cell 100. End portions of the sleeve 116 are wrapped in fire-resistant material 210. The fire-resistant material 210 of adjacent battery cells 100 abut one another and the battery cells 100 are packaged in a rectangular lattice. Due to the presence of the sleeves 116 and fire-resistant material 210 around ends of the sleeves 116, a body 202 is not used. The rectangular lattice is wrapped in one or more layers of fire-resistant material 210. In this embodiment, none of the battery cells 100 directly contact each other due to the presence of the fire-resistant material 210 around ends of the sleeve 116 and air gaps between middle portions of the sleeves 116. This feature reduces thermal transfer between battery cells 100. Also, negative terminals 104 are shielded by the bottom capture plate 118b. Further, due to fire-resistant material 210 and top capture plate 118, none of the positive terminals 102 has a line-of-sight with other of the battery cells 100. Further, in the event of a sidewall breach, adjacent battery cells 110 are protected by the fire-resistant material 210 and sleeve 116.

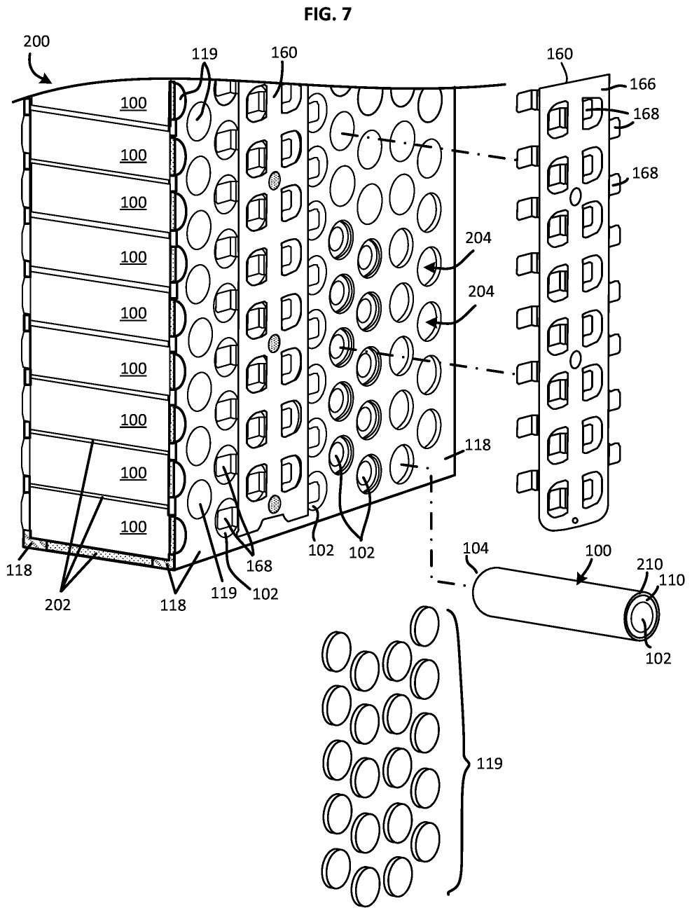

FIG. 7 illustrates a perspective and partially exploded view of part of a battery pack 200, in accordance with an embodiment of the present disclosure. In this example, the battery pack 200 includes a plurality of battery cells 100 retained in (or configured to be retained in) voids 204 defined in body 202. In this example, some voids 204 are empty to better show the structure of the battery pack 200. Each battery cell 100 has a positive terminal 102, a negative terminal 104, and an optional layer of fire-resistant material 210 around the container sidewall 110a (shown in FIG. 1). The body 202 is between adjacent battery cells 100 in the general shape of a honeycomb so as to preclude any direct contact between adjacent battery cells 100 and to obstruct a line of sight between adjacent battery cells 100. As a result of these and other features, propagation of thermal runaway event in one battery cell 100 can be greatly reduced or eliminated. For example, it has been found that direct contact between adjacent battery cells 100 nearly ensures propagation of thermal runaway from one of the battery cells 100 to the other.

Capture plates 118 abut the body 202 and define capture plate openings 118a over the positive terminals 102, negative terminals 104, or both. Potting material 119 occupies the volume of capture plate openings 118a to protect the terminal from ejecta 300 (shown in FIG. 5) that may be emitted from an adjacent battery pack 200 during a thermal runaway event, for example.

The bus bar 160 can be a plate with connector tabs 161, wire bonds, ribbon bonds, spring contacts, chemical bonds, or other suitable electrical connector or combination of connectors configured to make electrical contact with a plurality of battery cells 100 in a battery pack 200, in a cell module 150, or in some other grouping. In one embodiment, the bus bar 160 is formed of aluminum, copper, or nickel. Electrical connections between the battery cell 100 and the bus bar 160 can be formed using laser welding, resistive welding, ultrasonic welding, or friction stir welding, for example. The bus bar 160 can utilize series connections, parallel connections, or both among groups of battery cells 100. For example, positive terminals 102 in a row of battery cells 100 can be connected in series and adjacent rows can be connected in parallel. Numerous variations will be apparent in light of the present disclosure. In FIG. 7, one bus bar 160 is shown installed on the battery pack 200 with tabs 168 contacting positive terminals 102 of battery cells 100 (potting material 119 and other details not shown to reveal the tabs 168); another bus bar 160 is shown separate from the battery pack 200 to better show the structure of the plate 166 and tabs 168.

In the example of FIG. 7, none the installed battery cells 100 have a line of sight with one another due to the body 202 and/or capture plate 118 extending axially beyond the terminals 102, 104 of the battery cells 100. For example, the positive terminal 102 and negative terminal 104 of each battery cell 100 are recessed below the surface of the body 202. In doing so, any ejecta emitted from the positive terminal 102 of a battery cell 100 during a thermal runaway event would be obstructed by the body 202 and capture plate 118 from a direct linear path to any other battery cell 100 in the battery pack 200. Adjacent battery cells 100 are also isolated from one another by the body 202 in the event of any breach that develops in the container sidewall 110a.

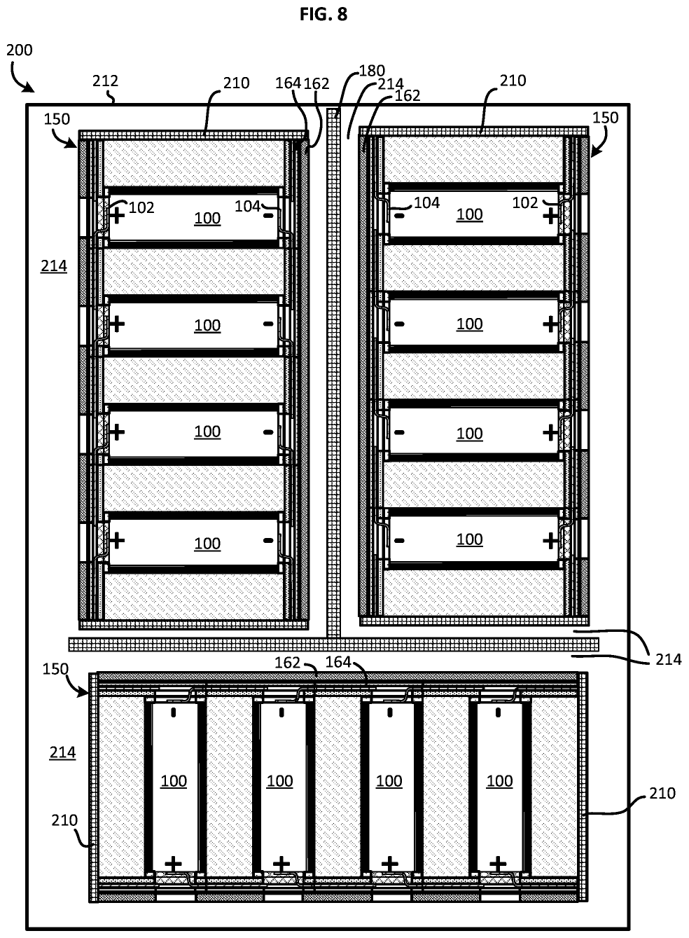

FIG. 8 illustrates a cross-sectional view of a battery pack 200 that includes a plurality of cell modules 150, in accordance with an embodiment of the present disclosure. Each cell module 150 in this example includes battery cells 100 and other components as shown in FIG. 4 and discussed above. The sidewall 201 of each cell module 150 is wrapped with fire-resistant material 210. The battery pack 200 has a housing 212 that contains a plurality of cell modules 150. Cell modules 150 are separated by baffles or partitions 180 of fire-resistant material, examples of which are discussed above. The partitions 180 function as a physical barrier to reduce or prevent heat transfer between adjacent cell modules 150 and to provide a barrier to prevent ejecta 300 from one battery cell 100 landing on another battery cell 100 or cell module 150.

Note also that in this example, positive terminals 102 are commonly aligned to point outward toward the housing 212, away from other cell modules 150, and away from an adjacent partition 180. Also, the negative terminals 104 of each battery cell 100 is closed off by the cold plate 162 and spacer 164. These features individually or in combination prevent ejecta 300 from a thermal runaway event from exiting through the negative terminals 104 and instead direct any ejecta 300 to exit axially through the positive terminal 102 of the battery cell 100. Each cell module 150 is also surrounded on some or all sides by an air gap 214. An air gap 214 further reduces heat transfer between adjacent cell modules 150 and therefore mitigates propagation of thermal runaway. The air gap 214 can function as an insulator, provides spacing between adjacent cell modules 150, and provides a volume for ejecta 300 to expand in the event of a thermal runaway event. The arrangement of cell modules 150, and partitions 180 shown in FIG. 8 requires a tortuous path in order for ejecta 300 from one battery cell 100 to land on another battery cell 100.

### Further Example Embodiments

The following examples pertain to further embodiments, from which numerous permutations and configurations will be apparent.

Example 1 is a lithium-ion battery assembly comprising a plurality of battery cells in a spaced-apart and generally parallel arrangement, each cell of the battery cells extending along a central axis and having a first end portion with a negative terminal and a second end portion with a positive terminal; a first capture plate and a second capture plate, at least the first capture plate defining capture plate openings corresponding to the plurality of battery cells, the first capture plate spaced from and oriented generally parallel to the second capture plate, wherein each of the plurality of battery cells extends between the first and second capture plates and is coaxially arranged with one of the capture plate openings in the first capture plate.

Example 2 includes the subject matter of Example 1, wherein each of the battery cells comprises a container having a cylindrical shape with an open end and a closed end, the container including the negative terminal; an electrode assembly in the container together with a lithium-ion electrolyte, the electrode assembly including a first electrode, a second electrode, and at least one spacer wound in a spiral configuration within the container such that the at least one spacer is between the first electrode and the second electrode; and a cap on the open end of the container, the cap including the positive terminal; wherein the negative terminal is electrically connected to the first electrode and the positive terminal is electrically connected to the second electrode.

Example 3 includes the subject matter of Example 2 and further comprises a current-interruptor device between the positive terminal and the second electrode.

Example 4 includes the subject matter of Examples 2 or 3 and further comprises a pressure disk adjacent the positive terminal, the pressure disk configured to rupture when a pressure within the container exceeds a threshold pressure.

Example 5 includes the subject matter of any of Examples 1-4, wherein the capture plate openings and the plurality of battery cells are arranged in a lattice, the lattice selected from a rectangular lattice, a triangular lattice, and a hexagonal lattice.

Example 6 includes the subject matter of Example 5, wherein the lattice is selected from a uniform square grid lattice, a non-uniform square grid lattice, a non-uniform hexagonal lattice, a uniform triangular lattice, a non-uniform triangular lattice.

Example 7 includes the subject matter of any of Examples 1-6, wherein the positive terminal of each of the plurality of battery cells is adjacent the first capture plate.

Example 8 includes the subject matter of any of Examples 1-6, wherein the positive terminal of some of the plurality of battery cells is adjacent the first capture plate and the positive terminal of others of the plurality of battery cells is adjacent the second capture plate.

Example 9 includes the subject matter of any of Examples 1-8, wherein each of the plurality of battery cells has dimensions of diameter x axial length selected from (i) 18 mm×65 mm, (ii) 21 mm×70 mm, and (iii) 26 mm×65 mm.

Example 10 includes the subject matter of any of Examples 1-9 and further comprises a layer of fire-resistant material around a sidewall of each of the plurality of battery cells.

Example 11 includes the subject matter of Example 10, wherein the layer of fire-resistant material is around at least end portions of the sidewall.

Example 12 includes the subject matter of Example 10 or 11, wherein the layer of fire-resistant material is around substantially all of the sidewall.

Example 13 includes the subject matter of any of Examples 10-12 and further comprises a sleeve around the sidewall, the sleeve between the battery cell and the layer of fire-resistant material.

Example 14 includes the subject matter of any of Examples 1-13 and further comprises a body between the first capture plate and the second capture plate, the body defining voids corresponding to each of the plurality of battery cells, wherein each of the plurality of battery cells is retained in one of the voids.

Example 15 includes the subject matter of Example 14, wherein the body has a thickness, the thickness greater than or equal to an axial length of each of the plurality of battery cells.

Example 16 includes the subject matter of Example 14 or 15 wherein the body is made of a material having a coefficient of thermal conductivity at 25° C. of at least 100 W/mK, preferably greater than 200 W/mK, more preferably greater than 400 W/mK.

Example 17 includes the subject matter of Example 14 or 15, wherein the body is made of a material having a coefficient of thermal conductivity at 25° C. of not greater than 1 W/mK, preferably not greater than 0.1 W/mK, more preferably not greater than 0.05 W/mK.

Example 18 includes the subject matter of any of Examples 1-17, wherein the second capture plate defines capture plate openings corresponding to the plurality of battery cells, each of the plurality of lithium-ion cells is coaxially arranged with one of the capture plate openings in the first capture plate and one of the capture plate openings in the second capture plate.

Example 19 includes the subject matter of any of Examples 1-18 and further comprises a bus bar between the first capture plate and the body, the bus bar electrically connected to the positive terminal of at least some of the plurality of battery cells.

Example 20 includes the subject matter of Example 19 further comprising a spacer between the bus bar and the capture plate, the spacer of an electrically insulating material.

Example 21 includes the subject matter of any of Examples 1-20, wherein subsets of the plurality of battery cells are electrically connected in series and wherein the subsets are electrically connected in parallel.

Example 22 includes the subject matter of any of Examples 1-21, wherein the first and second capture plates are extend axially beyond ends of the plurality of battery cells and the assembly further comprising a fire-resistant material in the capture plate opening over the positive terminal.

Example 23 is a battery pack comprising a housing; a plurality of cell modules within the housing, each cell module comprising a plurality of lithium ion battery cells having a positive terminal directed toward the housing; a partition of fire-resistant material between adjacent cell modules of the plurality of cell modules.

Example 24 includes the subject matter of Example 23, wherein each of the cell modules comprises a plurality of lithium-ion cells arranged in a spaced-apart and generally parallel arrangement, each cell of the lithium-ion cells having a first end portion with a negative terminal and a second end portion with a positive terminal; a first capture plate and a second capture plate, at least the first capture plate defining capture plate openings corresponding to the plurality of lithium-ion cells, the first capture plate spaced from and oriented generally parallel to the second capture plate, wherein each of the plurality of lithium-ion cells extends between the first and second capture plates and is coaxially arranged with one of the capture plate openings in the first capture plate.

Example 25 includes the subject matter of Example 23 or 24 and further comprises a layer of fire-resistant material around a sidewall of each cell module of the plurality of cell modules.

Example 26 includes the subject matter of Example 23 or 24 wherein the partitions and the plurality of cell modules are arranged to define an air gap between cell modules and the partitions

Example 27 includes the subject matter of any of Examples 23-26, wherein the positive terminals of the plurality of lithium ion battery cells are arranged in a square or triangular lattice.

Example 28 includes the subject matter of any of Examples 23-27, wherein each cell module further comprises a body defining voids, each of the voids containing one of the plurality of lithium ion battery cells; a first capture plate on a first side of the body, the first capture plate defining capture plate openings corresponding to the plurality of lithium ion battery cells; and a second capture plate on the second side of the body.

Example 29 includes the subject matter of any of Examples 23-28 and further comprises a fire resistant material in the capture plate openings, the fire resistant material covering the positive terminal of the plurality of lithium-ion cells.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future-filed applications claiming priority to this application may claim the disclosed subject matter in a different manner and generally may include any set of one or more limitations as variously disclosed or otherwise demonstrated herein.

What is claimed is:

1. A lithium-ion battery assembly comprising:
a plurality of battery cells in a spaced-apart and generally parallel arrangement, each cell of the battery cells extending along a central axis and having a first end portion with a negative terminal and a second end portion with a positive terminal; and
a first capture plate and a second capture plate, at least the first capture plate defining capture plate openings corresponding to the plurality of battery cells, the first capture plate spaced from and oriented generally parallel to the second capture plate, wherein each of the plurality of battery cells extends between the first and second capture plates and is coaxially arranged with one of the capture plate openings in the first capture plate.

2. The lithium-ion battery assembly of claim 1, wherein each of the battery cells comprises:
a container having a cylindrical shape with an open end and a closed end, the container including the negative terminal;
an electrode assembly in the container together with a lithium-ion electrolyte, the electrode assembly including a first electrode, a second electrode, and at least one spacer wound in a spiral configuration within the container such that the at least one spacer is between the first electrode and the second electrode;
a cap on the open end of the container, the cap including the positive terminal; and
a pressure disk adjacent the positive terminal, the pressure disk configured to rupture when a pressure within the container exceeds a threshold pressure.
wherein the negative terminal is electrically connected to the first electrode and the positive terminal is electrically connected to the second electrode.

3. The lithium-ion battery assembly of claim 1, wherein the capture plate openings and the plurality of battery cells are arranged in a lattice, the lattice selected from a uniform square grid lattice, a non-uniform square grid lattice, a non-uniform hexagonal lattice, a uniform triangular lattice, a non-uniform triangular lattice.

4. The lithium-ion battery assembly of claim 1, wherein the positive terminal of each of the plurality of battery cells is adjacent the first capture plate.

5. The lithium-ion battery assembly of claim 1 further comprising a layer of fire-resistant material around a sidewall of each of the plurality of battery cells.

6. The lithium-ion battery assembly of claim 5, wherein the layer of fire-resistant material is around substantially all of the sidewall.

7. The lithium-ion battery assembly of claim 5 further comprising a sleeve around the sidewall, the sleeve between the battery cell and the layer of fire-resistant material.

8. The lithium-ion battery assembly of claim 1 further comprising a body between the first capture plate and the second capture plate, the body defining voids corresponding to each of the plurality of battery cells, wherein each of the plurality of battery cells is retained in one of the voids.

9. The lithium-ion battery assembly of claim 8, wherein the body has a thickness, the thickness greater than or equal to an axial length of each of the plurality of battery cells.

10. The lithium-ion battery assembly of claim 8, wherein the body is made of a material having a coefficient of thermal conductivity at 25° C. of at least 100 W/mK.

11. The lithium-ion battery assembly of claim 8, wherein the body is made of a material having a coefficient of thermal conductivity at 25° C. of not greater than 1 W/mK.

12. The lithium-ion battery assembly of claim 1 further comprising a bus bar between the first capture plate and the body, the bus bar electrically connected to the positive terminal of at least some of the plurality of battery cells.

13. The lithium-ion battery assembly of claim 12, wherein subsets of the plurality of battery cells are electrically connected in series and wherein the subsets are electrically connected in parallel.

14. The lithium-ion battery assembly of claim 12 further comprising a spacer between the bus bar and the capture plate, the spacer of an electrically insulating material.

15. The lithium-ion battery assembly of claim 1, wherein the first and second capture plates are extend axially beyond ends of the plurality of battery cells and the assembly further comprising a fire-resistant material in the capture plate opening over the positive terminal.

16. A battery pack comprising:
a housing;
a plurality of cell modules within the housing, each cell module comprising a plurality of lithium ion battery cells, each battery cell having a positive terminal directed toward the housing; and
a partition of fire-resistant material between adjacent cell modules of the plurality of cell modules.

17. The battery pack of claim 16, wherein each of the cell modules comprises:
a plurality of lithium-ion cells arranged in a spaced-apart and generally parallel arrangement, each cell of the lithium-ion cells having a first end portion with a negative terminal and a second end portion with a positive terminal;
a body defining voids, each of the voids containing one of the plurality of lithium ion battery cells; and
a first capture plate on a first side of the body and a second capture plate on an opposite second side of the body, at least the first capture plate defining capture plate openings corresponding to the plurality of lithium-ion cells, wherein each of the plurality of lithium-ion cells extends between the first and second capture plates.

18. The battery pack of claim 17 further comprising a fire resistant material in the capture plate openings, the fire resistant material covering the positive terminal of the plurality of lithium-ion cells.

19. The battery pack of claim 17, further comprising a layer of fire-resistant material around an outside of each cell module of the plurality of cell modules.

20. The battery pack of claim 19 wherein the partitions and the plurality of cell modules are arranged to define an air gap between cell modules and the partitions.
